(19) United States
(12) Patent Application Publication
(10) Pub. No.: US 2009/0327586 A1
(43) Pub. Date: Dec. 31, 2009

(54) MEMORY DEVICE AND DATA STORING METHOD

(75) Inventor: Wu-Chi KUO, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: SILICON MOTION, INC., Hsinchu County (TW)

(21) Appl. No.: 12/258,700

(22) Filed: Oct. 27, 2008

(30) Foreign Application Priority Data
Jun. 25, 2008 (TW) 97123673

(51) Int. Cl. G06F 12/00; G06F 12/02; G06F 12/16

(52) U.S. Cl. 711/103; 711/161; 711/154; 711/E12.001; 711/E12.008; 711/E12.103

(57) ABSTRACT

A memory device is provided, comprising a single-level memory unit, a multi-level memory unit and a control unit. The single-level memory unit comprises a first link table and stores data according to the first link table. The multi-level memory unit comprises a second link table and stores data according to the second link table. The control unit directs data which normally belongs to the single-level memory unit to the multi-level memory unit or directs data which normally belongs to the multi-level memory unit to the single-level memory unit according to a control signal.

### CROSS REFERENCE TO RELATED APPLICATIONS

This Application also claims priority of Taiwan Patent Application No. 097123673, filed on Jun. 25, 2008, the entirety of which is incorporated by reference herein.

### BACKGROUND OF THE INVENTION

1. Field of the Invention

The invention relates to a memory device, and in particular relates to a memory device with a forward storing mechanism.

2. Description of the Related Art

An NAND memory can comprise single-level cells (SLC) or multi-level cells (MLC). A single-level cell can store two different digital values, 0 or 1. A multi-level cell can store four different digital values.

The advantages of the single-level cell are that it is stable and fast and the disadvantages thereof are that it has a relatively small storage capacity and high per storage capacity costs. The advantages of the multi-level cell are that it has a large storing capacity and low per storage capacity costs and the disadvantages thereof are that it is unstable and slow. Recently, embedded systems, such as digital cameras or cell phones, use NAND memories as storing media, for example, SD cards, MMC cards, MicroSD cards and CF cards. Due to ever increasing demand for larger storage space, most of the NAND memories use multi-level cells to store data. However, a high level embedded system, such as a laptop, needs to store operating system data to the NAND memories. If laptops use NAND memories comprising multi-level cells to store operating system data, the operating system data may be easily lost, thus making system operation during such a condition, a high risk operation. Meanwhile, laptop costs would increase if laptops use NAND memories comprising single-level cells to store operating system data for safety. Thus, a method for fully utilizing the advantages of SLC and MLC flash to store data is desired.

### BRIEF SUMMARY OF THE INVENTION

A detailed description is given in the following embodiments with reference to the accompanying drawings.

An embodiment of a memory device is provided. The memory device comprises a single-level cell memory unit, a multi-level cell memory unit and a control unit. The single-level cell memory unit comprises a first link table. The first link table records link relationships between logic addresses and physical addresses of the single-level cell memory unit. The multi-level cell memory unit comprises a second link table. The second link table records link relationships between logic addresses and physical addresses of the multi-level cell memory unit. The control unit directs data which normally belongs to the single-level cell memory unit to the multi-level cell memory unit or directs data which normally belongs to multi-level cell memory unit to the single-level cell memory unit according to a control signal.

An embodiment of a data storing method is provided. The data storing method comprises receiving a logic address and a data, detecting a flag, and directing the data to a single-level cell memory unit or a multi-level cell memory unit according to the flag and the logic address.

An embodiment of a data storing method is provided. The data storing method comprises sending a control signal to establish a flag, storing a data to a single-level cell memory unit or a multi-level cell memory unit according to the flag, and sending the control signal to unestablish the flag.

### BRIEF DESCRIPTION OF THE DRAWINGS

The invention can be more fully understood by reading the subsequent detailed description and examples with references made to the accompanying drawings, wherein:

FIG. 1 shows a memory device and a host according to an embodiment of the invention;

FIG. 2 shows an exchanging schematic diagram between the first link table of the single-level cell memory unit and the second link table of the multi-level cell memory unit according to an embodiment of the invention;

FIG. 3 shows a data storing method according to another embodiment of the invention; and

FIG. 4 shows a data storing method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

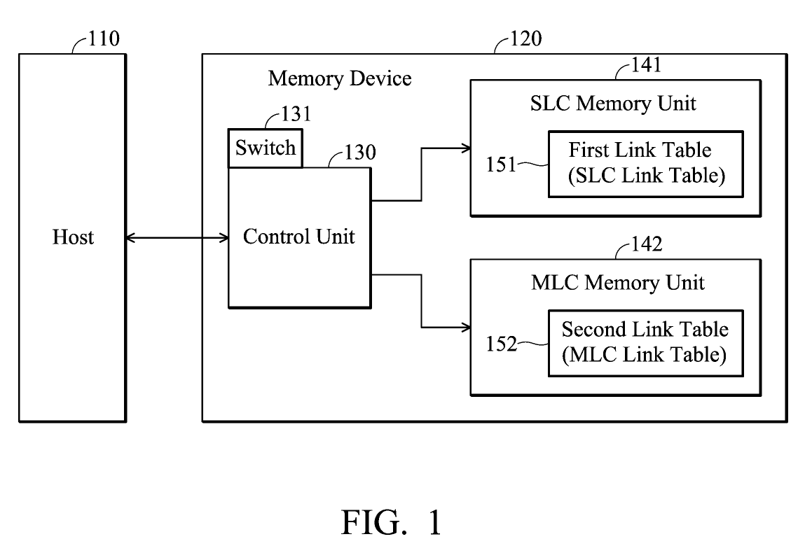

FIG. 1 shows a memory device 120 and a host 110 according to an embodiment of the invention. The memory device 120 uses an IDE interface, a USB interface or an SD-MMC interface to transmit/receive data with the host 110. The memory device 120 comprises a control unit 130, a single-level cell memory unit (SLC memory unit) 141 and a multi-level cell memory unit (MLC memory unit) 142. The control unit 130 receives data, logic addresses and control signals from the host 110 and determines to store data to the single-level cell memory unit 141 or the multi-level cell memory unit 142 according to the control signal and the logic addresses.

The control signal is established by a vendor command from the host 110 or by a switch 131. The single-level cell memory unit 141 comprises a first link table 151 and stores data according to physical addresses of the first link table 151 of the single-level cell memory unit 141. The multi-level cell memory unit 142 comprises a second link table 152 and stores data according to physical addresses of the second link table 152 of the multi-level cell memory unit 142. According to an embodiment of the invention, the control unit 130 directs data which normally belongs to the single-level cell memory unit 141 to the multi-level cell memory unit 142 or directs data which normally belongs to multi-level cell memory unit 142 to the single-level cell memory unit 141 according to the control signal. In addition, the logic addresses are used to determine where data belongs to.

According to another embodiment of the invention, the memory device 120 is a solid state drive (SSD) or a memory card, such as a CF card. The computer system conventionally uses a hard disk to store operation system data. However, the access speed of the hard disk is slower than that of the memory device 120. If the memory device 120 is a solid state drive for storing operation data or important data, the computer system can be faster, because the single-level cell memory unit 141 is more stable and has a longer operating life (more accessing times). For this embodiment, first, the host 110 transmits a vendor command to the control unit 130 to establish a flag as one. Next, the control unit 130 directs storage of important data or operation system data to the single-level cell memory unit 141 to avoid data lost while the data originally belongs to the multi-level memory unit.

According to another embodiment of the invention, a user manually controls the switch 131 to transmit the control signal to establish the flag as one. When the flag is established as one, the control unit 130 directs storage of important data or operation system data to the single-level cell memory unit 141 to avoid data lost.

The invention is not limited to directing storage of data to the single-level cell memory unit 141. Data can be also directed to be stored to the multi-level cell memory unit 142 under constraint.

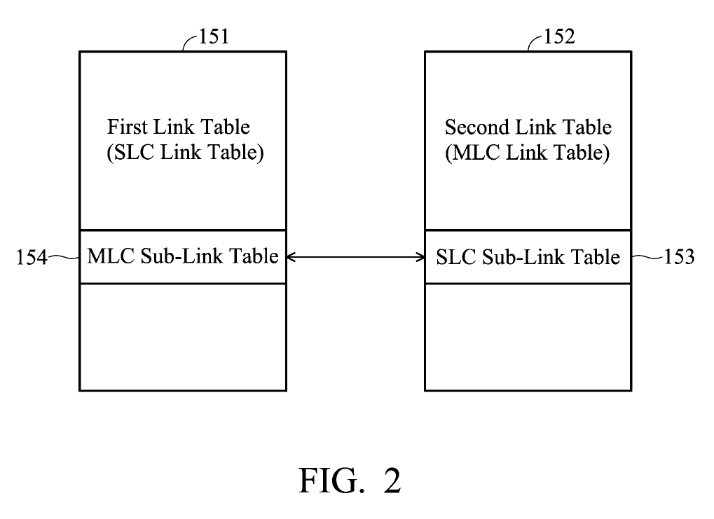

FIG. 2 shows an exchanging schematic diagram between the first link table 151 of the single-level cell memory unit and the second link table 152 of the multi-level cell memory unit according to an embodiment of the invention. Normally, the first link table 151 of the single-level cell memory unit 141 directs data to the physical addresses of the single-level cell memory unit 141, and the second link table 152 of the multi-level cell memory unit 142 directs data to the physical addresses of the multi-level cell memory unit 142.

In addition, when the control signal sets up the flag as one, the control unit 130 will direct data which normally belongs to the MLC memory unit 142 to the SLC memory unit 141. Thus, the SLC link table (first link table) 151 of the SLC memory unit 141 comprises a MLC sub-link table 154 which means some logic addresses of the SLC link table 151 originally directed to physical addresses of the SLC memory unit 141 are now directed to the physical addresses of the MLC memory unit 142. On the other hand, the MLC link table (second link table) 152 of the MLC memory unit 142 also comprises an SLC sub-link table 153 which means some logic addresses of the MLC link table 152 originally directed to physical addresses of the MLC memory unit 142 are now directed to the physical address of the SLC memory unit 141, as shown in FIG. 2.

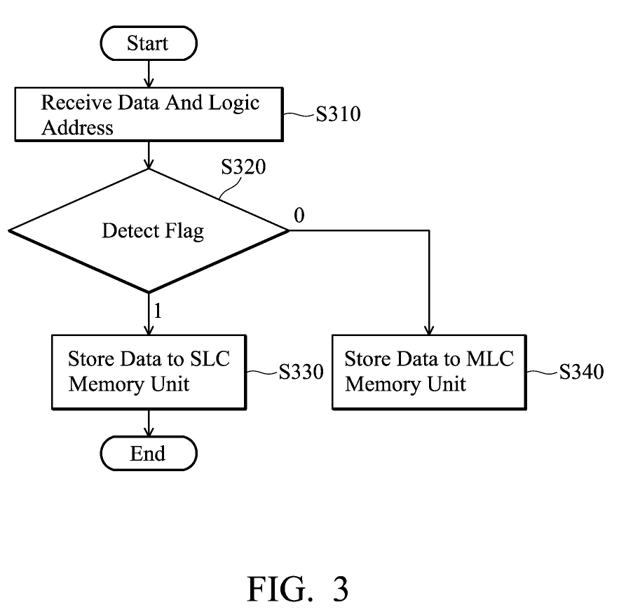

FIG. 3 shows a data storing method according to another embodiment of the invention. First, the control unit 130 receives data and the logic addresses (Step S310). Then, the control unit 130 detects the flag (Step S320). The flag controls whether data is stored to the SLC memory unit 141 or the MLC memory unit 152. If data is an important data or an operation system data, the flag is established as one to direct data to be stored to the SLC memory unit 141 to avoid data lost (Step S330). If the control unit 130 detects that the flag as zero, the control unit 130 will store data to the MLC memory unit 142 (Step S340).

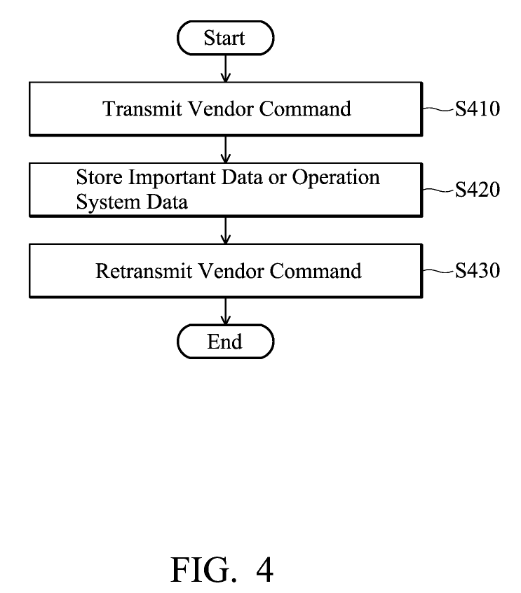

FIG. 4 shows a data storing method according to another embodiment of the invention. The host 110 transmits the vendor command (Step S410) to establish the flag as one. When the control unit 130 detects that the flag as one, the data (important data or operation system data) is stored to the SLC memory unit 141 (Step S420) and the control unit 130 records the physical address and corresponding logical address of the important data in the SLC sub-link table. Then the host retransmits the vendor command to unestablish the flag as zero to not direct data which belongs to MLC memory unit 142 to be stored to the SLC memory unit 141 (Step S430). If the flag is zero, the control unit 130 stores data to the SLC memory unit 141 or the MLC memory unit 142 according to the logic addresses.

Since the SLC memory unit 141 is more stable and has longer operating life, the invention uses the control signal to establish the flag as a particular value and detects whether the flag equals to the particular value or not to direct data which normally belongs to the MLC memory unit 142 to the SLC memory unit 141 to avoid data lost.

While the invention has been described by way of example and in terms of preferred embodiment, it is to be understood that the invention is not limited to thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A memory device for accessing data, comprising:
a single-level cell memory unit comprising a first link table, wherein the first link table records link relationships between logic addresses and physical addresses of the single-level cell memory unit;
a multi-level cell memory unit comprising a second link table, wherein the second link table records link relationships between logic addresses and physical addresses of the multi-level cell memory unit; and
a control unit selectively directing data which normally belongs to the single-level cell memory unit to the multi-level cell memory unit or directing data which normally belongs to multi-level cell memory unit to the single-level cell memory unit according to a control signal.

2. The memory device as claimed in claim 1, wherein the control unit comprises a switch thereby user manually controls the switch to transmit the control signal.

3. The memory device as claimed in claim 1, wherein the control unit receives the control signal from a host and sets up a flag as a predetermined value according to the control signal for directing data to the multi-level cell memory unit or the single-level-cell memory unit.

4. The memory device as claimed in claim 3, wherein the control signal is established by a vendor command.

5. The memory device as claimed in claim 1, wherein when the data is important data or operating system data, the control signal sets up a flag as a predetermined value for directing the important data or the operating system data to the single-level cell memory unit.

6. The memory device as claimed in claim 1, wherein when directing data which normally belongs to the multi-level cell memory unit to the single-level cell memory unit, the control unit adjusts the first link table to correspond to the physical addresses of the multi-level cell memory unit.

7. The memory device as claimed in claim 1, wherein when directing data which normally belongs to the single-level cell memory unit to the multi-level cell memory unit, the control unit adjusts the second link table to correspond to the physical addresses of the single-level cell memory unit.

8. A data storing method, comprising:
receiving a logic address and a data;
detecting a flag; and
directing the data to a single-level cell memory unit or a multi-level cell memory unit according to the flag and the logic address.

9. The data storing method as claimed in claim 8, wherein the flag is determined by a control signal and the control signal is generated by a host or user settings.

10. The data storing method as claimed in claim 8, wherein when the flag is established as a predetermined value, the data which normally belongs the multi-level cell memory is directed to be stored in the single-level cell memory.

11. The data storing method as claimed in claim 8, wherein the single-level cell memory unit comprises a first link table and the multi-level cell memory unit comprises a second link table, wherein the first link table and the second link table comprise link relationships between the logic addresses and a physical addresses of the respective cell memory units.

12. The data storing method as claimed in claim 11, wherein when the flag is established as a predetermined value, the first link table is adjusted to link to the physical address of the multi-level cell memory unit.

13. The data storing method as claimed in claim 8, wherein the flag is established by a vendor command.

14. A data storing method, comprising:
sending a control signal to establish a flag;
storing a data to a single-level cell memory unit or a multi-level cell memory unit according to the flag; and
sending the control signal to unestablish the flag.

15. The data storing method as claimed in claim 14, wherein the control signal is generated by a host or user settings.

16. The data storing method as claimed in claim 14, wherein when the flag is established as a predetermined value, the data which normally belongs to the multi-level cell memory is directed to be stored in the single-level cell memory.

17. The data storing method as claimed in claim 14, wherein the single-level cell memory unit comprises a first link table and the multi-level cell memory unit comprises a second link table, wherein the first link table and the second link table comprise link relationships between the logic addresses and a physical addresses of the respective cell memory units.

18. The data storing method as claimed in claim 17, wherein when the flag is established as a predetermined value, the first link table is adjusted to link to the physical address of the multi-level cell memory unit.

19. The data storing method as claimed in claim 14, wherein the flag is established by a vendor command.
